(19) United States
(12) Patent Application Publication
(10) Pub. No.: US 2010/0235592 A1
(43) Pub. Date: Sep. 16, 2010

(54) DATE VOLUME MIGRATION WITH MIGRATION LOG CONFIRMATION

(76) Inventors: Yasunori Kaneda, San Jose, CA (US); Toshio Otani, Sunnyvale, CA (US)

Correspondence Address: MATTINGLY & MALUR, P.C., 1800 DIAGONAL ROAD, SUITE 370, ALEXANDRIA, VA, 22314, US

(21) Appl. No.: 12/401,035

(22) Filed: Mar. 10, 2009

(51) Int. Cl. G06F 13/00; G06F 12/00; G06F 12/16; G06F 12/02

(52) U.S. Cl. 711/161; 711/E12.001; 711/E12.002; 711/E12.103

(57) ABSTRACT

Exemplary embodiments provide data volume migration with migration log confirmation in which the same data volume identifier is used beyond migration for a data volume. In one embodiment, data is migrated to or from a data volume in a data storage area of a storage apparatus. The data being migrated is identified by a data volume identifier which remains unchanged after migration. The same data volume identifier is used in both the source data volume and the destination data volume. The storage apparatus stores migration log information of the data volume. The migration log information includes the data volume identifier, a source name of the source data volume of the data being migrated, a destination name of the destination data volume of the data being migrated, and log information on any prior migration of the data being migrated.

### BACKGROUND OF THE INVENTION

The present invention relates generally to data volume migration and, more particularly, to data volume migration with migration log confirmation in which the same data volume identifier is used beyond migration for a data volume.

In a conventional storage area network, each data volume is identified by an identifier that is composed of a WWN (World Wide Name) and a LUN (Logical Unit Number) commonly. WWNs are given to Fibre Channel ports. LUNs are given to data volumes connected to the ports. Thus, each data volume can be identified by a WWN and a LUN (see FIG. 9). In the case of replacement of a storage apparatus, data in a data volume in an old storage apparatus is migrated to a data volume in a new storage apparatus in order to keep providing the same data to host computers after the migration.

Currently identifiers are given to the data volumes. These identifiers (each is a combination of a WWN and a LUN) are changed after the migration even if the data is not changed. Host computers, management computers, and/or administrators of the computer systems have to know the identifier relations between the old data volumes and the new data storages for replacing storage apparatus correctly.

To avoid the complexity of changing the identifiers beyond the migration, it is possible to use the same data volume identifier for a data volume beyond the migration. In that case, an old data volume in the old storage apparatus and a new data volume in the new storage apparatus have same data volume identifier. Consequently, it is impossible to distinguish between new/old or source/destination by the data volume identifier.

The use of the same identifier for a data volume beyond migration gives rise to another issue. Fabric zoning for a Fibre Channel Fabric in a storage area network is a technology used for preventing illegal access. The zoning uses the WWN of the port. Before connecting a new data volume to a zone, the zoning setting must be modified so that the new data volume can join the zone. After modifying the zone, an old data volume (a source data volume) cannot join the zone. Thus, the host computers cannot mount the old data volume. In the case where the same data volume identifier is used beyond the migration, the new data volume uses the same identifier inherited from the old data volume, and zoning modification is not required before connecting the new data volume. However, the old data volume can be joined to the zone because the same identifier is used for the new data volume. In such a situation, it is difficult to distinguish between the old data volume (source volume) from the new data volume (destination volume). If the old data volume is connected to the Fabric by mistake, the new computer system does not work correctly. U.S. Pat. No. 6,765,919 discloses a method and a system for zoning, but it does not teach preventing an old data volume from joining the zone when the same identifier is used for the new data volumes.

To avoid the aforementioned difficulties and mistakes, the present invention addresses the situation in which the same data volume identifier is used beyond migration for a data volume.

### BRIEF SUMMARY OF THE INVENTION

Exemplary embodiments of the invention provide data volume migration with migration log confirmation in which the same data volume identifier is used beyond migration for a data volume. Persistent data volume identifiers are used for data volume identification. The same persistent data volume identifier is used for a data volume beyond migrations. To distinguish between an old data volume and a new data volume with the same data volume identifier after migration, the storage apparatuses store data volume migration log information for the data volume. The data volume migration log information can be used to identify the latest data volume for a data volume identifier after one or more data volume migrations.

In accordance with an aspect of the present invention, a storage system comprises a storage apparatus including a processor and a data storage area. Data is migrated to or from a data volume in the data storage area of the storage apparatus. The data volume in the data storage area of the storage apparatus is a source data volume if the data is migrated from the data volume to another data volume, and the data volume in the data storage area of the storage apparatus is a destination data volume if data is migrated to the data volume. The data being migrated is identified by a data volume identifier which remains unchanged after migration, and the same data volume identifier is used in both the source data volume and the destination data volume. The storage apparatus stores migration log information of the data volume. The migration log information includes the data volume identifier, a source name of the source data volume of the data being migrated, a destination name of the destination data volume of the data being migrated, and log information on any prior migration of the data being migrated.

In some embodiments, the migration log information includes a migration timestamp at a time of generating the migration log information, a migration status of the migration of the data being migrated, and a generation number indicating a number of times the data has been migrated.

In specific embodiments, the data is migrated between the data volume in the data storage area of the storage apparatus and another data volume in another storage apparatus. The storage apparatus performs one of obtaining migration log information of the source data volume including log information on any prior migration of the data in the source data volume, and updating the migration log information to include the migration of the data from the source data volume to the destination data volume; or generating new migration log information of the migration of the data from the source data volume to the destination data volume.

In some embodiments, the data is migrated between the data volume in the data storage area of the storage apparatus and another data volume in another storage apparatus. The storage system further comprises a data migration apparatus connected between the two storage apparatuses. The data migration apparatus performs one of obtaining migration log information of the source data volume including log information on any prior migration of the data in the source data volume, updating the migration log information to include the migration of the data from the source data volume to the destination data volume, and providing the updated migration log information to at least one of the two storage apparatuses; or generating new migration log information of the migration of the data from the source data volume to the destination data volume, and providing the new migration log information to at least one of the two storage apparatuses.

In specific embodiments, a network is connected to the storage apparatus. The network includes a plurality of switches belonging to a plurality of zones, each switch being permitted to access a data volume belonging to the same zone as said each switch. Prior to permitting data flow between one of the switches and a target data volume in the same zone as the one switch, the one switch obtains the migration log information of the target data volume, determines whether the data in the target data volume has been migrated to another data volume based on the migration log information, and permits data flow between the one switch and the target data volume if the data has not been migrated to another data volume. At least two data volumes have the same data volume identifier after data migration between the at least two data volumes. Prior to permitting data flow between one of the switches and any of the at least two data volumes, the one switch compares the migration log information of the at least two data volumes, determines which of the at least two data volumes is the latest data volume based on the migration log information, and permits data flow between the one switch and the latest data volume.

In accordance with another aspect of the invention, a data migration method comprises migrating data to or from a data volume in the data storage area of the storage apparatus; wherein the data volume in the data storage area of the storage apparatus is a source data volume if the data is migrated from the data volume to another data volume, and the data volume in the data storage area of the storage apparatus is a destination data volume if data is migrated to the data volume; wherein the data being migrated is identified by a data volume identifier which remains unchanged after migration, and the same data volume identifier is used in both the source data volume and the destination data volume; and storing, in the storage apparatus, migration log information of the data volume, the migration log information including the data volume identifier, a source name of the source data volume of the data being migrated, a destination name of the destination data volume of the data being migrated, and log information on any prior migration of the data being migrated.

Another aspect of the invention is directed to a computer-readable storage medium storing a plurality of instructions for controlling a data processor to manage data flow in a storage system that includes a data storage area. The plurality of instructions comprise instructions that cause the data processor to migrate data to or from a data volume in the data storage area of the storage apparatus; wherein the data volume in the data storage area of the storage apparatus is a source data volume if the data is migrated from the data volume to another data volume, and the data volume in the data storage area of the storage apparatus is a destination data volume if data is migrated to the data volume; wherein the data being migrated is identified by a data volume identifier which remains unchanged after migration, and the same data volume identifier is used in both the source data volume and the destination data volume; and instructions that cause the data processor to store, in the storage apparatus, migration log information of the data volume, the migration log information including the data volume identifier, a source name of the source data volume of the data being migrated, a destination name of the destination data volume of the data being migrated, and log information on any prior migration of the data being migrated.

These and other features and advantages of the present invention will become apparent to those of ordinary skill in the art in view of the following detailed description of the specific embodiments.

### BRIEF DESCRIPTION OF THE DRAWINGS

FIG. 1(a) illustrates an example of a hardware configuration in which the method and apparatus of the invention may be applied.

FIG. 1(b) illustrates additional details of the storage apparatus of FIG. 1(a).

FIG. 1(c) illustrates an example of a data migration apparatus.

FIG. 1(d) illustrates an example of HDD recording area to data volumes mapping.

FIG. 2 shows an example of a zoning configuration in FIG. 1(a).

FIG. 3(a) shows an example of a device identifier which the first storage apparatus 100a of FIG. 1(a) provides.

FIG. 3(b) shows an example of a device identifier which the second storage apparatus 100b of FIG. 1(a) provides.

FIG. 4 is a flow diagram illustrating a method of replacing the first storage apparatus 100a with the second storage apparatus 100b of FIG. 1(a).

FIG. 5(a) shows a configuration in which two storage apparatuses are connected directly for data migration.

FIG. 5(b) shows a configuration in which two storage apparatuses are connected via a data migration apparatus for data migration.

FIG. 6(a) shows an example of data volume migration log information for a data volume migrated from the first storage apparatus to the second storage apparatus (1111a to 1111b).

FIG. 6(b) shows an example of data volume migration log information for the data volume of FIG. 6(a) after additional migration from the second storage apparatus to the third storage apparatus (1111b to 1111c).

FIG. 6(c) shows an example of data volume migration log information for the data volume of FIG. 6(a) after additional migration within the second storage apparatus (1111b to 1113b), and from the second storage apparatus to the third storage apparatus (1113b to 1111c).

FIG. 7 illustrates that data volume migration log information is created for each migrated data volume in a storage apparatus.

FIG. 8 shows examples of data volume migration log display program outputs.

FIG. 9 illustrates that each data volume in a conventional storage area network is identified by an identifier which is composed of the WWN (World Wide Name) of the corresponding Fibre Channel port and the LUN (Logical Unit Number) of the data volume connected to the port.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for data volume migration with migration log confirmation in which the same data volume identifier is used beyond migration for a data volume. One example of storage migration is found in U.S. application Ser. No. 12/232,348 entitled Method and Apparatus for Storage Migration, filed Sep. 16, 2008, the entire disclosure of which is incorporated herein by reference.

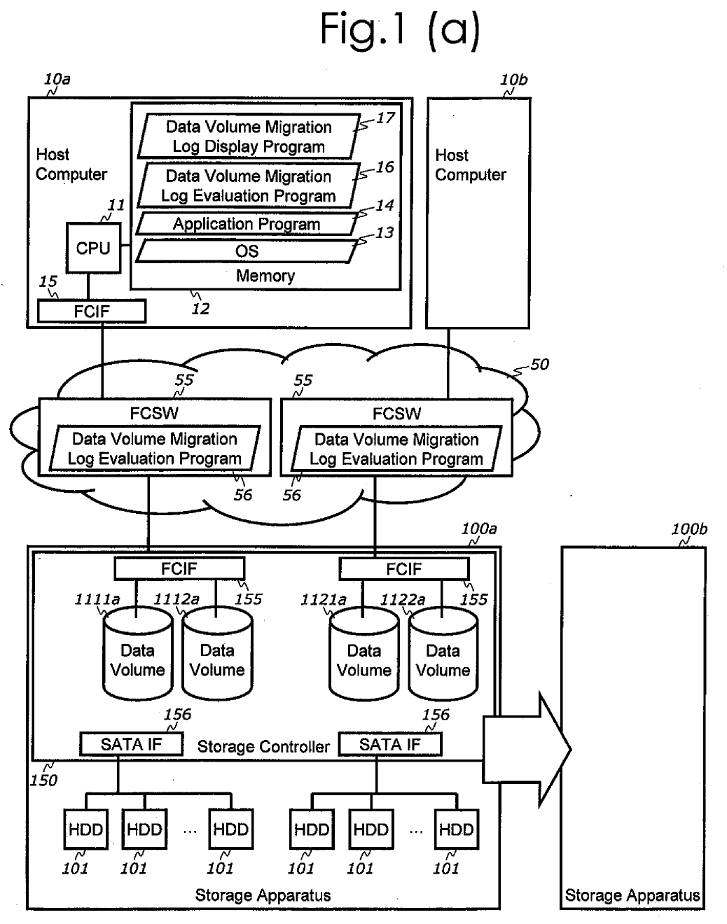

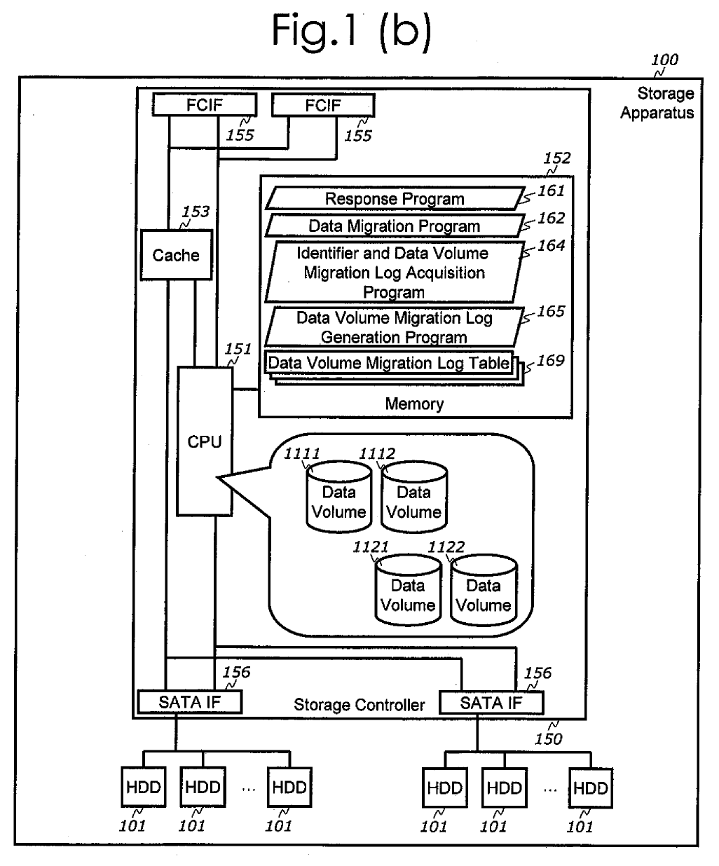

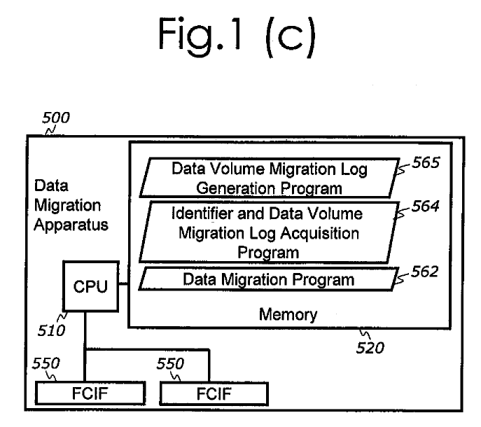

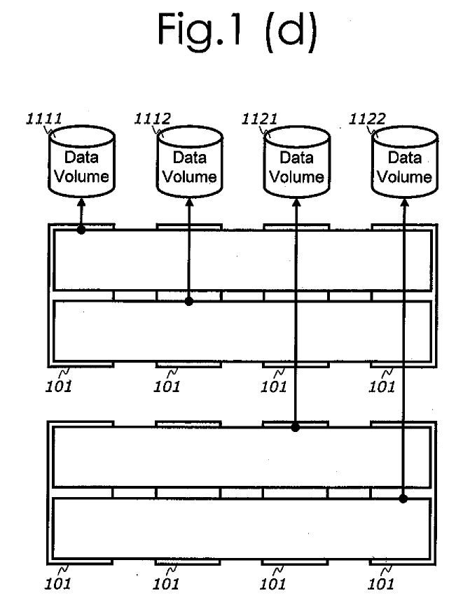

FIG. 1(a) illustrates an example of a hardware configuration in which the method and apparatus of the invention may be applied. The system includes at least one host computer 10 connected to a storage apparatus 100 via a Fabric 50. In this embodiment, two host computers 10a and 10b are connected to the first storage apparatus 100a via the Fabric 50. A CPU 11 executes various programs stored in a memory 12. A Fibre Channel interface (FCIF) 15 is provided to interface with a switch FCSW 55 in the Fabric 50. At least one operating system program (OS) 13 is executed on the first host computer 10a. An application program 14 may be executed on the OS 13. Other programs include the data volume migration log evaluation program 16 and data volume migration log display program 17. Files and data for the OS 13 and the application program 14 are stored in data volumes, which are provided by the first storage apparatus 100a. The OS 13 and the application program 14 issue write and/or read commands to the first storage apparatus 100a. The first host computer 10a is identified by WWN10a. The second host computer 10b is identified by WWN10b.

In the Fabric 50, the switch 55 includes a data volume migration log evaluation program 56. The host computers 10a, 10b and the first storage apparatus 100a are connected via the switches 55 in the Fabric 50. The Fabric 50 in this embodiment is a Fibre Channel Fabric. In other embodiments, another network such as an Ethernet can be used. Network switches and hubs can be used for connecting the host computers and the storage apparatus. In FIG. 1(a), two Fibre Channel switches (FCSW) 55 are used for connecting two host computers 10a, 10b, respectively, to the first storage apparatus 100a. The host computers 10a, 10b and the first storage apparatus 100a each have one or more Fibre Channel interface boards (FCIF) 15 for connecting to the Fabric 50.

FIG. 1(b) illustrates additional details of the storage apparatus 100 (100a or 100b) of FIG. 1(a). In the storage apparatus 100, one or more HDDs 101 are used for storing data, and one or more storage controllers 150 provide data volumes to the host computers 10. The storage controller 150 includes Fibre Channel interfaces FCIF 155 for interfacing with the switches 55 of the Fabric 50, and SATA IF 156 for interfacing with a plurality of HDDs 101. If the HDD has a different interface such as FC or SCSI SAS, another appropriate interface should be implemented. The storage controller 150 includes a cache 153 for storing data received from the host computer and data read from the HDDs, and a CPU 151 that executes programs stored in a memory 152. The memory 152 stores a response program 161 for responding to at least READ/WRITE/INQUIRY/READ CAPACITY commands from the host computer 10, a data migration program 162 for migrating data in data volumes, an identifier and data volume migration log acquisition program 164 for acquiring identifiers and data volume migration log information, a data volume migration log generation program 165 for generating data volume migration log information and associating the information to data volume, and a data volume migration log table 169.

The storage apparatus 100 provides one or more data volumes to the host computer 10 (10a, 10b). In the embodiment of FIG. 1(b), four data volumes 1111, 1112, 1121 and 1122 are provided. The data volume 1111 is identified by WWN111 and LUN0. The data volume 1112 is identified by WWN111 and LUN1. The data volume 1121 is identified by WWN112 and LUN0. The data volume 1122 is identified by WWN112 and LUN1. In the embodiment of FIG. 1(a), the first storage apparatus 100a will be replaced with the second storage apparatus 100b. Data in the data volumes in the first storage apparatus 100a will be migrated to new data volumes in the second storage apparatus 100b according to the present invention as described in greater detail below. The identifier assigned to each data volume in the first storage apparatus 100a is inherited by the corresponding new data volume in the second storage apparatus 100b beyond migration.

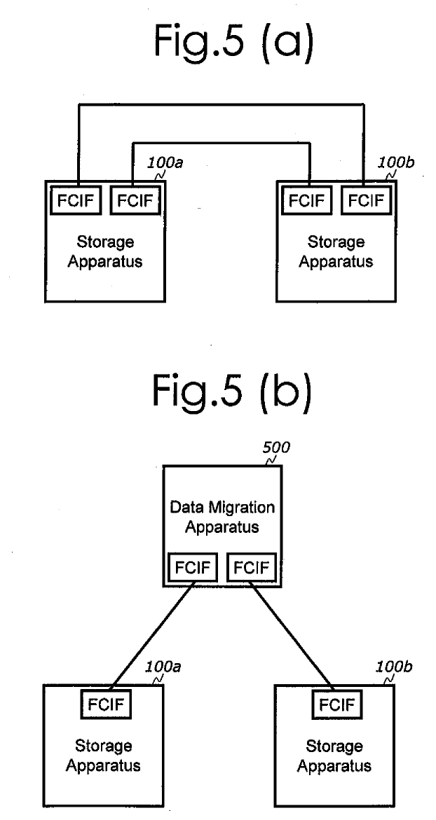

FIG. 1(c) illustrates an example of a data migration apparatus which is used for data migration in the embodiment shown in FIG. 5(b) as described below. The data migration apparatus 500 includes a CPU 510 for executing programs stored in a memory 520, and a Fibre Channel interface FCIF 550 for connecting to the storage apparatuses 100a, 100b. The programs may include a data migration program 562 for migrating data in data volumes, an identifier and data volume migration log acquisition program 564 for acquiring identifiers and data volume migration log information, and a data volume migration log generation program 565 for generating data volume migration log information and associating the information to data volume, and providing the generated data volume migration log information to destination data volumes.

FIG. 1(d) illustrates an example of HDD recording area to data volumes mapping. The storage apparatus 100 provides plural data volumes. Each volume is composed of part of HDD recording areas. RAID technology may be applied to the mapping.

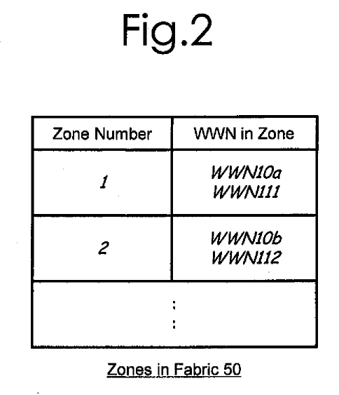

In the embodiment of FIG. 1(a), the switches FCSW 55 in the Fabric 50 provide two zones by zoning capabilities. FIG. 2 shows a zoning configuration in this embodiment. Communications among host computers and data volumes are allowed in each zone. For example, the first host computer 10a can access the data volumes 1111 and 1112 in one zone, but cannot access the data volumes 1121 and 1122 because they are in a different zone.

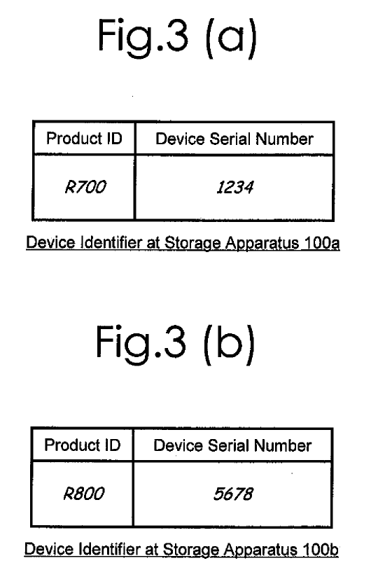

FIG. 3(a) shows an example of a device identifier which the first storage apparatus 100a of FIG. 1(a) provides. The identifier is composed of product ID and device serial number. In the embodiment of FIGS. 1(a) and 1(b), the first storage apparatus 100a does not have a data volume migration log table 169. The first storage apparatus 100a can provide a device identifier according to requests from the identifier and data volume migration log acquisition program 164 in the second storage apparatus 100b.

FIG. 3(b) shows an example of a device identifier which the second storage apparatus 100b of FIG. 1(a) provides. The data volume migration log table 169 in the second storage apparatus 100b is initially empty. The second storage apparatus 100b can provide a device identifier according to requests from the identifier and data volume migration log acquisition program 164 even if the data volume migration log table 169 is empty. The identifier and data volume migration log acquisition program 164 in the second storage apparatus 100b in the second storage apparatus 100b issues a SCSI INQUIRY command for this purpose.

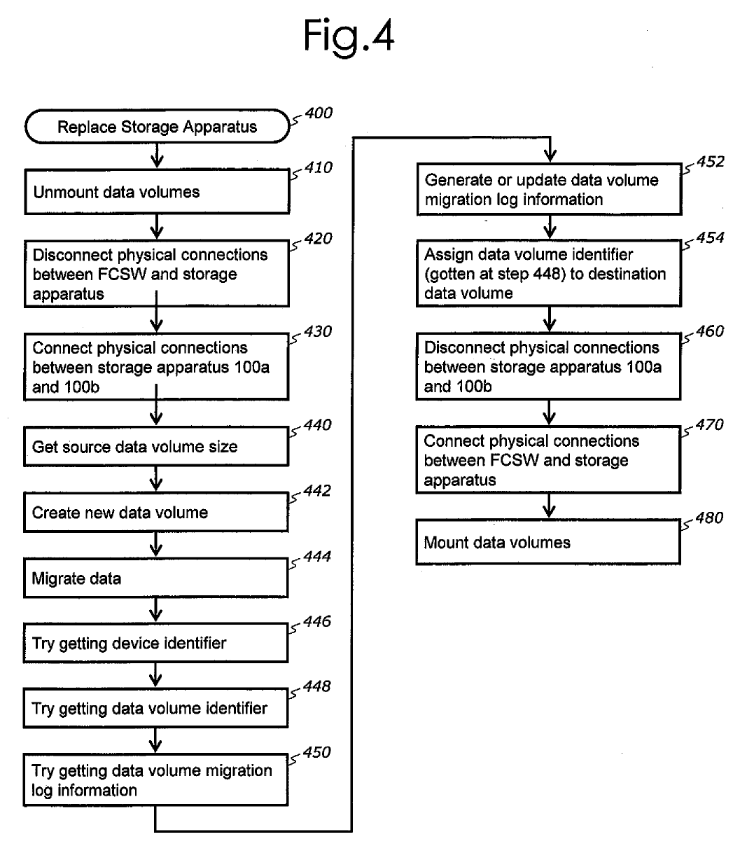

FIG. 4 is a flow diagram illustrating a method of replacing the first storage apparatus 100a with the second storage apparatus 100b of FIG. 1(a), beginning in step 400. In step 410, the data volumes in the first storage apparatus 100a to be replaced are unmounted. In step 420, physical connections between the switch FCSW 55 in the Fabric 50 and the first storage apparatus 100a are disconnected. In step 430, physical connections between the first and second storage apparatuses 100a and 100b are connected. FIG. 5(a) shows a configuration in which the two storage apparatuses are connected directly with each other. Data is migrated by the data migration program 162 in the second storage apparatus 100b. FIG. 5(b) shows a configuration in which two storage apparatuses are connected via a data migration apparatus 500 (see FIG. 1(c)) according to another embodiment. Data is migrated by the data migration program 562 in the data migration apparatus 500.

In step 440, the data migration program (162 or 562) obtains the source data volume size by issuing one or more SCSI READ CAPACITY commands for the source data volumes in the first storage apparatus 100a. In step 442, the data migration program creates the new (destination) data volumes in the second storage apparatus 100b. In step 444, the data migration program migrates data from the source data volumes to the destination data volumes. In the embodiment shown in FIGS. 1(a) and 1(b), the source data volume 1111a is migrated to the destination data volume 1111b, the source data volume 1112a is migrated to the destination data volume 1112b, the source data volume 1121a is migrated to the destination data volume 1121b, and the source data volume 1122a is migrated to destination data volume 1122b.

In step 446, the identifier and data volume migration log acquisition program (164 or 564) obtains the device identifier of the first storage apparatus 100a by issuing a SCSI INQUIRY command with a specific VPD page number. In step 448, the identifier and data volume migration log acquisition program obtains the data volume identifier (combination of WWN and LUN) of each source data volume that is migrated by issuing a SCSI INQUIRY command with a specific VPD page number. In step 450, the identifier and data volume migration log acquisition program obtains the data volume migration log information for each source data volume that is migrated by issuing a SCSI INQUIRY command with a specific VPD page number. U.S. Pat. No. 7,114,020 discloses methods for identifying SCSI devices by two step information acquisition. Some information types are disclosed for the identification. However, that patent does not disclose information types which are related to data volume migration log, and does not teach any methods to prevent mounting old data volumes according to historical information.

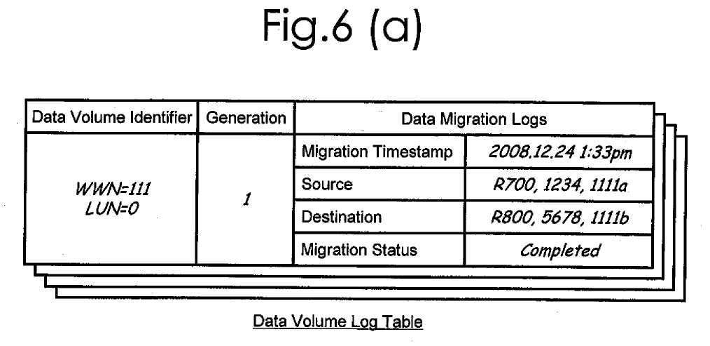

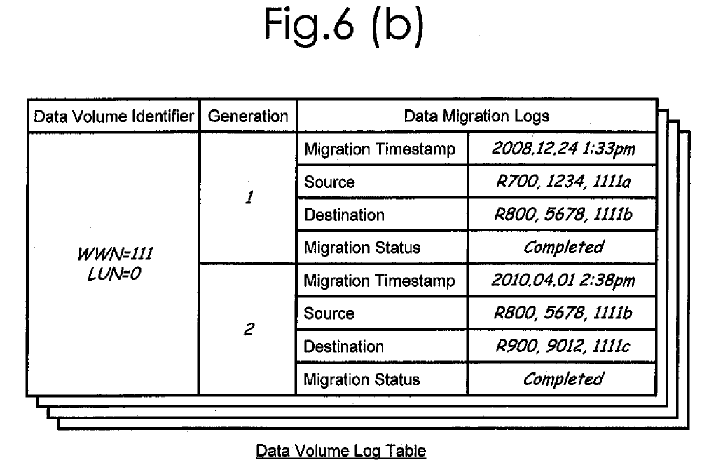

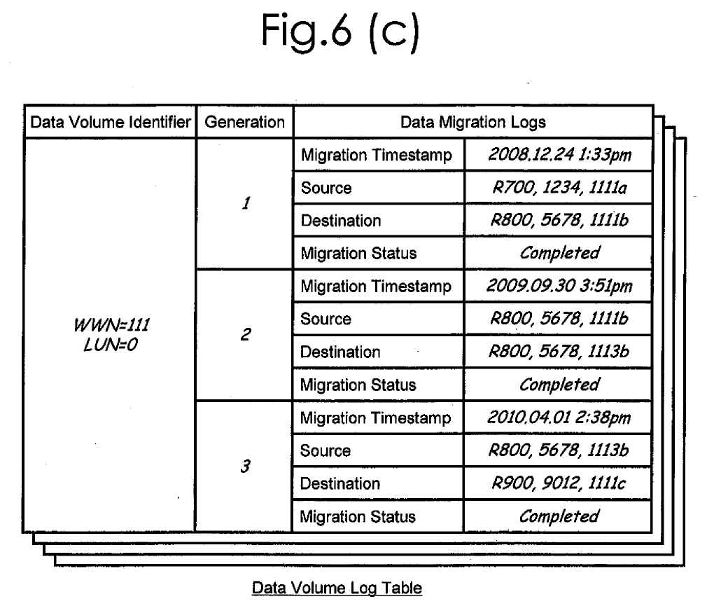

In step 452, the data volume migration log generation program (165 or 565) newly generates or updates data volume migration log information according to the device identifier, the data volume identifier, any prior data volume migration log information, migration result (e.g., migration status of “completed,” “migrating,” “aborted by disconnection,” “aborted by read error,” “aborted by write error,” “aborted by user operation”), and timestamp (at the time of generating or updating the migration log information). The data volume migration log information is stored in the data volume migration log table 169 in the second storage apparatus 100b (see FIG. 6 below).

In step 454, the data migration program (162 or 562) assigns the data volume identifier obtained in step 448 to the migrated data volume (destination data volume) in the second storage apparatus 100b. After this point, the same data volume identifier is associated with both the source data volume and the migrated destination data volume in the computer system. Data migration steps are executed until all source data volumes in the first storage apparatus 100a are migrated to the second storage apparatus 100b.

In step 460, the physical connections between the storage apparatuses 100a and 100b are disconnected. If the data migration apparatus 500 is used, it is disconnected from the two storage apparatuses 100a and 100b. In step 470, the physical connections between the FCSW 55 and the second storage apparatus 100b are connected. In step 480, the new data volumes in the second storage apparatus 100b are mounted. The same data volume identifiers are used. Thus, no modification is required on the host computers and Fabric zoning.

As seen in FIG. 1(a), the host computers 10 may have the data volume migration log evaluation program 16 for checking the data volume migration log. Administrators may provide the time range, source identifier, destination identifier, and/or migration status to the data volume migration log evaluation program 16. In the data volume mount process in the host computer, nonaligned data volumes relative to the given condition are prevented from being mounted. In contrast, only current connected device identifier can be acquired in the prior art.

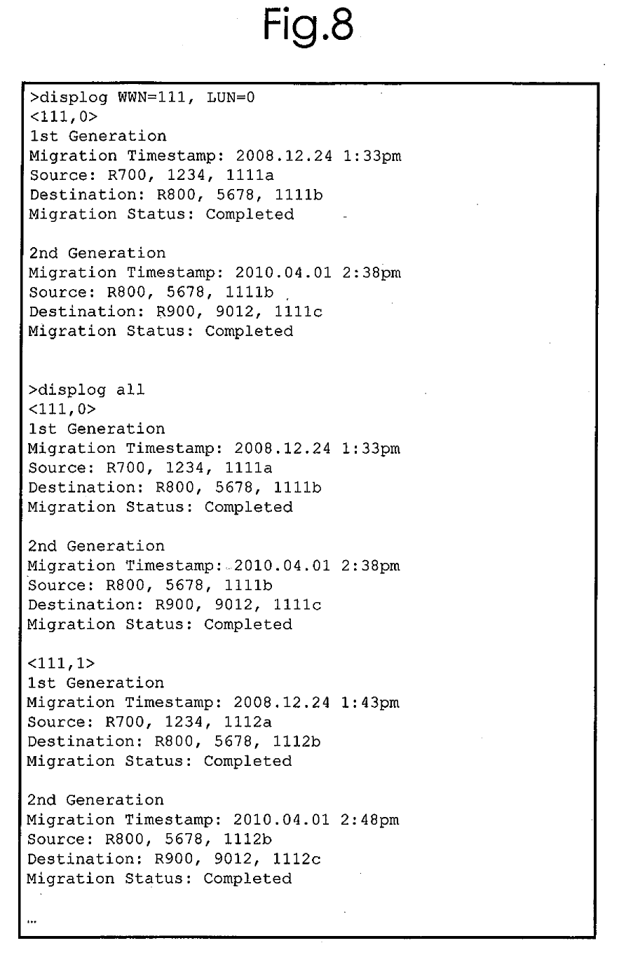

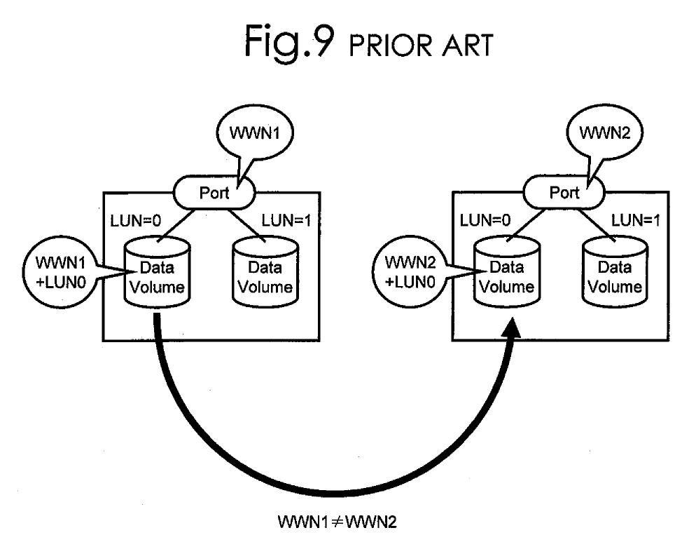

The host computer 10 may have the data volume migration log display program 17 for indicating or displaying the data volume migration log to administrators on the host computer. The administrators can read the data volume migration log and evaluate whether the current connected data volume is right or not. FIG. 8 shows one of the examples of data volume migration log display program outputs. The “displog” command line interface is used with a specific data volume identifier or “all” in FIG. 8.

In the Fabric 50 of FIG. 1(a), the switch FCSW 55 may have the data volume migration log evaluation program 56 for checking the data volume migration log information. In the case of connecting both an old storage apparatus 100a and a new storage apparatus 100b (all or some data volumes have been already migrated and data volume identifiers are inherited), the same identifiers for old and new data volumes are found in one Fabric when the data volumes are logged in. This is invalid in the prior art. In the present invention, the data volume migration log evaluation program 56 in the FCSW 55 gets the data volume migration log information from the storage apparatuses 100a, 100b and compares the two data volume migration log information. The data volume migration log evaluation program 56 can identify the latest data volume and can prevent login from the old storage apparatus 100a. In this case, the data volume migration log information may be provided with the Fabric login process.

The migration status in the data volume migration log information may indicate not only “completed,” but also “migrating,” “aborted by disconnection,” “aborted by read error,” “aborted by write error,” “aborted by user operation,” and the like.

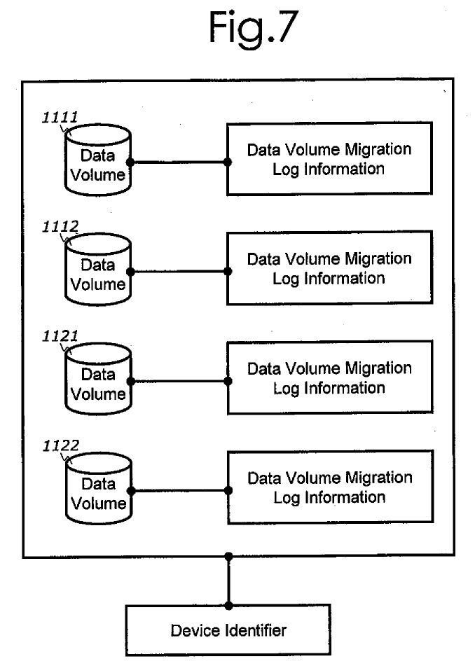

FIG. 6(a) shows an example of data volume migration log information for a data volume migrated from the first storage apparatus to the second storage apparatus (1111a to 1111b). FIG. 7 illustrates that data volume migration log information is created for each migrated data volume in a storage apparatus. The data volume migration log information includes, for a given data volume, the migration source and destination, as well as the migration status. It typically also includes the migration timestamp at the time of generating or updating the log information. The data volume identifier is typically recorded to identify the data volume. If the data volume undergoes multiple migrations, the log information will include the generation number as shown in FIGS. 6(b) and 6(c).

FIG. 6(b) shows an example of data volume migration log information for the data volume of FIG. 6(a) after an additional migration from the second storage apparatus to the third storage apparatus (1111b to 1111c). In the case where both the source storage apparatus 100b and the destination storage apparatus 100c support this data volume migration log capability, the data volume migration log information is inherited to the destination data volumes. In FIG. 6(b), the data volume migration log shows the following. In generation 1, data was migrated from the data volume 1111a in the first storage apparatus 100a (device ID=R700, device serial number=1234) to the data volume 1111b in the second storage apparatus 100b (device ID=R800, device serial number=5678). In generation 2, data was migrated from the data volume 1111b in the second storage apparatus 100b (device ID=R800, device serial number=5678) to the data volume 1111c in the third storage apparatus 100c (device ID=R900, device serial number=9012).

FIG. 6(c) shows an example of data volume migration log information for the data volume of FIG. 6(a) after additional migrations within the second storage apparatus (1111b to 1113b), and from the second storage apparatus to the third storage apparatus (1113b to 1111c). Data migrations within one storage apparatus are sometimes executed. In this case, one generation for the internal migration should be added to the data volume migration log information. In FIG. 6(c), the data volume migration log shows the following. In generation 1, data was migrated from the data volume 1111a in the first storage apparatus 100a (device ID=R700, device serial number=1234) to the data volume 1111b in the second storage apparatus 100b (device ID=R800, device serial number=5678). In generation 2, data was migrated within the second storage apparatus 100b (device ID=R800, device serial number=5678). The data was migrated from the data volume 1111b to the data volume 1131b. In generation 3, data was migrated from the data volume 1113b in second storage apparatus 100b (device ID=R800, device serial number=5678) to the data volume 1111c in the third storage apparatus 100c (device ID=R900, device serial number=9012).

The present invention is used for data storage appliances which especially support persistent data volume identifiers beyond migrations. With the existing technology, the data volume identifier (combination of WWN and LUN) is changed in the case of migration from an old data storage apparatus to a new data storage apparatus. An administrator can identify source and destination data volume by comparing an old device identifier and a new device identifier. To apply a persistent data volume identifier (combination of virtual WWN (and LUN)) to a data volume, the same identifier is used beyond migrations. In this situation, the administrators cannot distinguish between an old data volume and a new data volume by the persistent data volume identifier. This invention provides technology for identifying the old and new data volume by providing data volume migration log information. The data volume migration log information may be provided on SCSI INQUIRY command response. SCSI protocol is currently used on Fibre Channel, IP network and FCoE (Fibre Channel over Ethernet).

Of course, the system configurations illustrated in FIGS. 1 and 5 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for data volume migration with migration log confirmation in which the same data volume identifier is used beyond migration for a data volume. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a storage apparatus including a processor and a data storage area;
wherein data is migrated to or from a data volume in the data storage area of the storage apparatus;
wherein the data volume in the data storage area of the storage apparatus is a source data volume if the data is migrated from the data volume to another data volume, and the data volume in the data storage area of the storage apparatus is a destination data volume if data is migrated to the data volume;
wherein the data being migrated is identified by a data volume identifier which remains unchanged after migration, and the same data volume identifier is used in both the source data volume and the destination data volume; and
wherein the storage apparatus stores migration log information of the data volume, the migration log information including the data volume identifier, a source name of the source data volume of the data being migrated, a destination name of the destination data volume of the data being migrated, and log information on any prior migration of the data being migrated.

2. A storage system according to claim 1,
wherein the migration log information includes a migration timestamp at a time of generating the migration log information, a migration status of the migration of the data being migrated, and a generation number indicating a number of times the data has been migrated.

3. A storage system according to claim 1,
wherein the data is migrated between the data volume in the data storage area of the storage apparatus and another data volume in another storage apparatus; and
wherein the storage apparatus performs one of:
obtaining migration log information of the source data volume including log information on any prior migration of the data in the source data volume, and updating the migration log information to include the migration of the data from the source data volume to the destination data volume; or
generating new migration log information of the migration of the data from the source data volume to the destination data volume.

4. A storage system according to claim 1, wherein the data is migrated between the data volume in the data storage area of the storage apparatus and another data volume in another storage apparatus, the storage system further comprising a data migration apparatus connected between the two storage apparatuses, wherein the data migration apparatus performs one of:
obtaining migration log information of the source data volume including log information on any prior migration of the data in the source data volume, updating the migration log information to include the migration of the data from the source data volume to the destination data volume, and providing the updated migration log information to at least one of the two storage apparatuses; or
generating new migration log information of the migration of the data from the source data volume to the destination data volume, and providing the new migration log information to at least one of the two storage apparatuses.

5. A storage system according to claim 1, further comprising:
a network connected to the storage apparatus, the network including a plurality of switches belonging to a plurality of zones, each switch being permitted to access a data volume belonging to the same zone as said each switch,
wherein, prior to permitting data flow between one of the switches and a target data volume in the same zone as the one switch, the one switch obtains the migration log information of the target data volume, determines whether the data in the target data volume has been migrated to another data volume based on the migration log information, and permits data flow between the one switch and the target data volume if the data has not been migrated to another data volume.

6. A storage system according to claim 5,
wherein at least two data volumes have the same data volume identifier after data migration between the at least two data volumes; and
wherein, prior to permitting data flow between one of the switches and any of the at least two data volumes, the one switch compares the migration log information of the at least two data volumes, determines which of the at least two data volumes is the latest data volume based on the migration log information, and permits data flow between the one switch and the latest data volume.

7. A data migration method comprising:
migrating data to or from a data volume in the data storage area of the storage apparatus; wherein the data volume in the data storage area of the storage apparatus is a source data volume if the data is migrated from the data volume to another data volume, and the data volume in the data storage area of the storage apparatus is a destination data volume if data is migrated to the data volume; wherein the data being migrated is identified by a data volume identifier which remains unchanged after migration, and the same data volume identifier is used in both the source data volume and the destination data volume; and
storing, in the storage apparatus, migration log information of the data volume, the migration log information including the data volume identifier, a source name of the source data volume of the data being migrated, a destination name of the destination data volume of the data being migrated, and log information on any prior migration of the data being migrated.

8. A data migration method according to claim 7,
wherein the migration log information includes a migration timestamp at a time of generating the migration log information, a migration status of the migration of the data being migrated, and a generation number indicating a number of times the data has been migrated.

9. A data migration method according to claim 7, wherein the data is migrated between the data volume in the data storage area of the storage apparatus and another data volume in another storage apparatus, the method further comprising performing one of:
obtaining migration log information of the source data volume including log information on any prior migration of the data in the source data volume, and updating the migration log information to include the migration of the data from the source data volume to the destination data volume; or
generating new migration log information of the migration of the data from the source data volume to the destination data volume.

10. A data migration method according to claim 7, wherein the data is migrated between the data volume in the data storage area of the storage apparatus and another data volume in another storage apparatus, and wherein a data migration apparatus is connected between the two storage apparatuses, the method further comprising performing by the data migration apparatus one of:
obtaining migration log information of the source data volume including log information on any prior migration of the data in the source data volume, updating the migration log information to include the migration of the data from the source data volume to the destination data volume, and providing the updated migration log information to at least one of the two storage apparatuses; or
generating new migration log information of the migration of the data from the source data volume to the destination data volume, and providing the new migration log information to at least one of the two storage apparatuses.

11. A data migration method according to claim 7, wherein a network is connected to the storage apparatus, the network including a plurality of switches belonging to a plurality of zones, each switch being permitted to access a data volume belonging to the same zone as said each switch, the method further comprising:
prior to permitting data flow between one of the switches and a target data volume in the same zone as the one switch, obtaining the migration log information of the target data volume, determining whether the data in the target data volume has been migrated to another data volume based on the migration log information, and permitting data flow between the one switch and the target data volume if the data has not been migrated to another data volume.

12. A data migration method according to claim 11, wherein at least two data volumes have the same data volume identifier after data migration between the at least two data volumes, the method further comprising:
prior to permitting data flow between one of the switches and any of the at least two data volumes, comparing the migration log information of the at least two data volumes, determining which of the at least two data volumes is the latest data volume based on the migration log information, and permitting data flow between the one switch and the latest data volume.

13. A computer-readable storage medium storing a plurality of instructions for controlling a data processor to manage data flow in a storage system that includes a data storage area, the plurality of instructions comprising:
instructions that cause the data processor to migrate data to or from a data volume in the data storage area of the storage apparatus; wherein the data volume in the data storage area of the storage apparatus is a source data volume if the data is migrated from the data volume to another data volume, and the data volume in the data storage area of the storage apparatus is a destination data volume if data is migrated to the data volume; wherein the data being migrated is identified by a data volume identifier which remains unchanged after migration, and the same data volume identifier is used in both the source data volume and the destination data volume; and
instructions that cause the data processor to store, in the storage apparatus, migration log information of the data volume, the migration log information including the data volume identifier, a source name of the source data volume of the data being migrated, a destination name of the destination data volume of the data being migrated, and log information on any prior migration of the data being migrated.

14. A computer-readable storage medium according to claim 13,
wherein the migration log information includes a migration timestamp at a time of generating the migration log information, a migration status of the migration of the data being migrated, and a generation number indicating a number of times the data has been migrated.

15. A computer-readable storage medium according to claim 13, wherein the data is migrated between the data volume in the data storage area of the storage apparatus and another data volume in another storage apparatus, the plurality of instructions further comprising instructions that cause the data processor to perform one of:
obtaining migration log information of the source data volume including log information on any prior migration of the data in the source data volume, and updating the migration log information to include the migration of the data from the source data volume to the destination data volume; or
generating new migration log information of the migration of the data from the source data volume to the destination data volume.

16. A computer-readable storage medium according to claim 13, wherein the data is migrated between the data volume in the data storage area of the storage apparatus and another data volume in another storage apparatus, and wherein a data migration apparatus is connected between the two storage apparatuses, the plurality of instructions further comprising instructions that cause a processor of the data migration apparatus to perform one of:
obtaining migration log information of the source data volume including log information on any prior migration of the data in the source data volume, updating the migration log information to include the migration of the data from the source data volume to the destination data volume, and providing the updated migration log information to at least one of the two storage apparatuses; or
generating new migration log information of the migration of the data from the source data volume to the destination data volume, and providing the new migration log information to at least one of the two storage apparatuses.

17. A computer-readable storage medium according to claim 13, wherein a network is connected to the storage apparatus, the network including a plurality of switches belonging to a plurality of zones, each switch being permitted to access a data volume belonging to the same zone as said each switch, the plurality of instructions further comprising instructions that cause the data processor to:
prior to permitting data flow between one of the switches and a target data volume in the same zone as the one switch, obtain the migration log information of the target data volume, determine whether the data in the target data volume has been migrated to another data volume based on the migration log information, and permit data flow between the one switch and the target data volume if the data has not been migrated to another data volume.

18. A computer-readable storage medium according to claim 17, wherein at least two data volumes have the same data volume identifier after data migration between the at least two data volumes, the plurality of instructions further comprising instructions that cause the data processor to:
prior to permitting data flow between one of the switches and any of the at least two data volumes, compare the migration log information of the at least two data volumes, determine which of the at least two data volumes is the latest data volume based on the migration log information, and permit data flow between the one switch and the latest data volume.
